(19) United States
(12) Patent Application Publication
(10) Pub. No.: US 2025/0014842 A1
(43) Pub. Date: Jan. 9, 2025

(54) SWITCHING DEVICE

(71) Applicant: U-SHIN LTD., Nagano (JP)

(72) Inventor: Yasuhiko KIRIHARA, Hiroshima City (JP)

(21) Appl. No.: 18/761,557

(22) Filed: Jul. 2, 2024

(30) Foreign Application Priority Data
Jul. 7, 2023 (JP) 2023-112401

(51) Int. Cl. H01H 9/16; H01F 27/32

(52) U.S. Cl. CPC H01H 9/168; H01F 27/325

(57) ABSTRACT

The switching device has a cylindrical body. A bobbin portion is provided at the front-end portion of the body, and an antenna wire is wound around the bobbin portion. A substrate is disposed inside the body, and a connector terminal is provided on rear surface of the substrate. Further, the substrate is provided with an antenna connection portion conductive to the connector terminal, and one end portion and other end portion of the antenna wire are soldered to the antenna connection portion. Thus, the antenna wire can be connected to the connector terminal while the body is manufactured inexpensively compared with a body for insert molding a connecting terminal. Therefore, manufacturing costs of the switching device can be reduced.

### CROSS-REFERENCE TO RELATED APPLICATIONS

This application claims the benefit of priority to Japanese Patent Application Number 2023-112401 filed on Jul. 7, 2023. The entire contents of the above-identified application are hereby incorporated by reference.

### TECHNICAL FIELD

The present invention relates to a switching device.

### BACKGROUND ART

In the switching device described in Patent Literature 1 below, an antenna coil is wound around one end portion of a cylindrical body, and a coil terminal is inserted in a body. Said one end portion of the coil terminal protrudes from the body, and an end portion of the antenna coil is wound around said one end portion of the coil terminal. Other end portion of the coil terminal, on the other hand, protrudes from the body inside a connector housing and is configured as a connector terminal. This allows communication operation with the antenna coil.

### PATENT LITERATURE

Japanese Unexamined Patent Application Publication No. 2015-187968

### SUMMARY OF INVENTION

### Technical Problem

However, as described above, the above switching device requires the coil terminal to be integrally formed into the body by insert molding, which may increase manufacturing costs of the switching device. Therefore, there is room for improvement in the above switching device in terms of reducing the manufacturing costs.

Considering the above fact, the present invention aims to provide the switching device that can reduce the manufacturing costs.

### Solution to Problem

One or more embodiments of the invention is a switching device comprising: a body formed in a cylindrical shape and having a bobbin portion at one end portion; an antenna wire wound around the bobbin portion; a slider configured to be slidable in axial direction of the body within the body; a switching portion pressed by the slider when sliding to other end of the body in the slider; and a substrate that is disposed inside the body and has a connector terminal, with an antenna connection portion that is conductive to the connector terminal and connected to an end portion of the antenna wire.

### Advantageous Effect of Invention

According to the switching device of the above configuration, the manufacturing costs can be reduced.

### BRIEF DESCRIPTION OF DRAWINGS

FIG. 1A is a side view of a switching device according to the present embodiment from one side in first direction.

FIG. 1B is a front view from front side of the switching device illustrated in FIG. 1A.

FIG. 2 is a longitudinal cross-sectional view of the switching device illustrated in FIG. 1B from said one side in the first direction (a 2-2 line cross-sectional view of FIG. 1B).

FIG. 3 is the longitudinal cross-sectional view of the switching device illustrated in FIG. 1B from said one side in second direction (a 3-3 line cross-sectional view of FIG. 1B).

FIG. 4 is a cross-sectional view of a case and a body illustrated in FIG. 2 from the front side, indicating other end portion in the second direction (a 4-4 line cross-sectional view of FIG. 2).

FIG. 5 is the cross-sectional view of the switching device illustrated in FIG. 2 from said one side in the first direction and other side in the second direction, illustrating the switching device with the case removed from the body.

FIG. 6 is a diagram of a substrate illustrated in FIG. 5, viewed from the other side in the second direction, in a state before it is housed in the body.

FIG. 7 is the diagram of the substrate illustrated in FIG. 6, viewed from the other side in the second direction, in the state in which the substrate is housed in the body and an antenna wire wound around a bobbin portion is connected to an antenna wire connection portion.

### DESCRIPTION OF EMBODIMENT

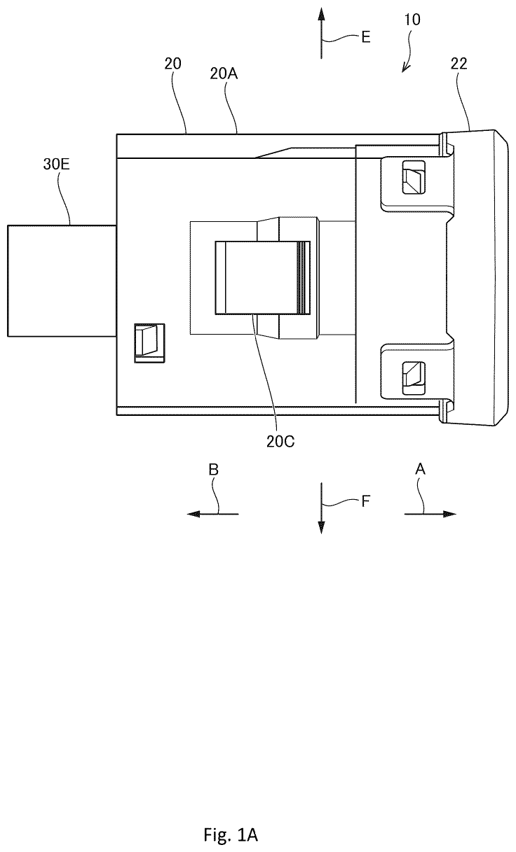

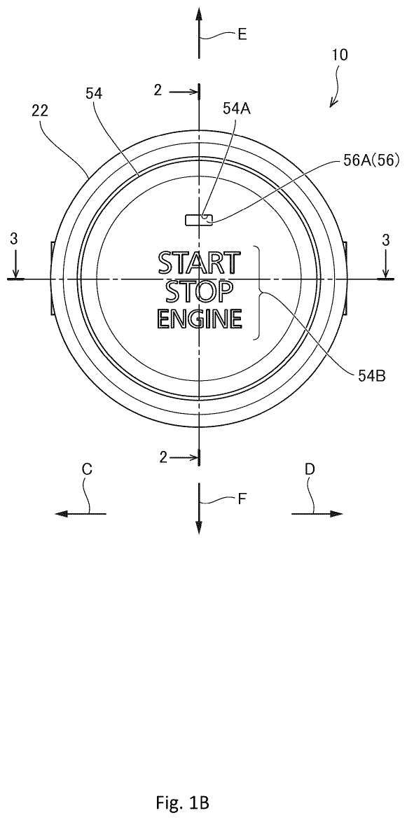

A switching device 10 according to the present embodiment will be described below, using drawings. The switching device 10 of the present embodiment is disposed on such as an instrument panel of a vehicle (automobile) and is configured as a device for starting or stopping an engine (power unit) of the vehicle. As illustrated in FIG. 1A and FIG. 1B, the switching device 10 is formed as a whole in a substantially cylindrical shape. In the following description, one side of the switching device 10 in axial direction (side in direction of arrow A in FIG. 1A) is front side of the switching device 10, and other side in the axial direction of the switching device 10 (the side in the direction of arrow B in FIG. 1A) is rear side of the switching device 10. In a front view from the front side, the direction orthogonal to front-back direction is first direction (see arrows C and D in FIG. 1B), and the direction orthogonal to the first direction is second direction (see arrows E and F in FIG. 1B). Furthermore, the side in the direction of arrow C in FIG. 1B is said one side in the first direction, and the side in the direction of arrow E in FIG. 1B is said one side in the second direction.

As illustrated in FIG. 1 to FIG. 3, the switching device 10 includes a case 20, a body 30, a switch mechanism 40, and an antenna wire 60. Each configuration of the switching device 10 will be described below.

### Case 20

The case 20 is formed in a double, substantially cylindrical shape with the front-back direction as the axial direction. In other words, the case 20 has an outer cylinder 20A and an inner cylinder 20B, with the inner cylinder 20B disposed radially inward of the outer cylinder 20A. Both end portions in the second direction at front-end portions of the outer cylinder 20A and the inner cylinder 20B are coupled with each other. A pair of fixing pieces 20C are formed on an outer circumference of the outer cylinder 20A on both side portions in the first direction. The fixing piece 20C is inclined forward as it moves radially outward from the case 20, as viewed from the second direction. The fixing piece 20C is engaged with the instrument panel of the vehicle and so on to fix the case 20 (i.e., the switching device 10) to the vehicle. An inner circumference of a rear end portion of the outer cylinder 20A is formed with a fitting recess 20D that is lowered one step radially outward. The inner cylinder 20B is formed in a substantially bottomed cylinder shape open to the front side, and the rear wall of the inner cylinder 20B is positioned more forward than the rear end portion of the outer cylinder 20A. A rear wall of the inner cylinder 20B is suitably formed with holes for exposing a portion of a rubber contact 50 and for inserting a lens 56, which will be described further below.

A bezel 22 is assembled to the front-end portion of the case 20. Specifically, the front-end portion of the case 20 is provided with a fitting cylindrical portion 20E in a cylindrical shape, and the fitting cylindrical portion 20E protrudes forward from the front-end portion of the outer cylinder 20A. The bezel 22 is formed in the substantially cylindrical shape with the front-back direction as the axial direction. The bezel 22 is inserted into the fitting cylindrical portion 20E and is assembled to the outer cylinder 20A by means of a claw fit to prevent relative movement.

### Body 30

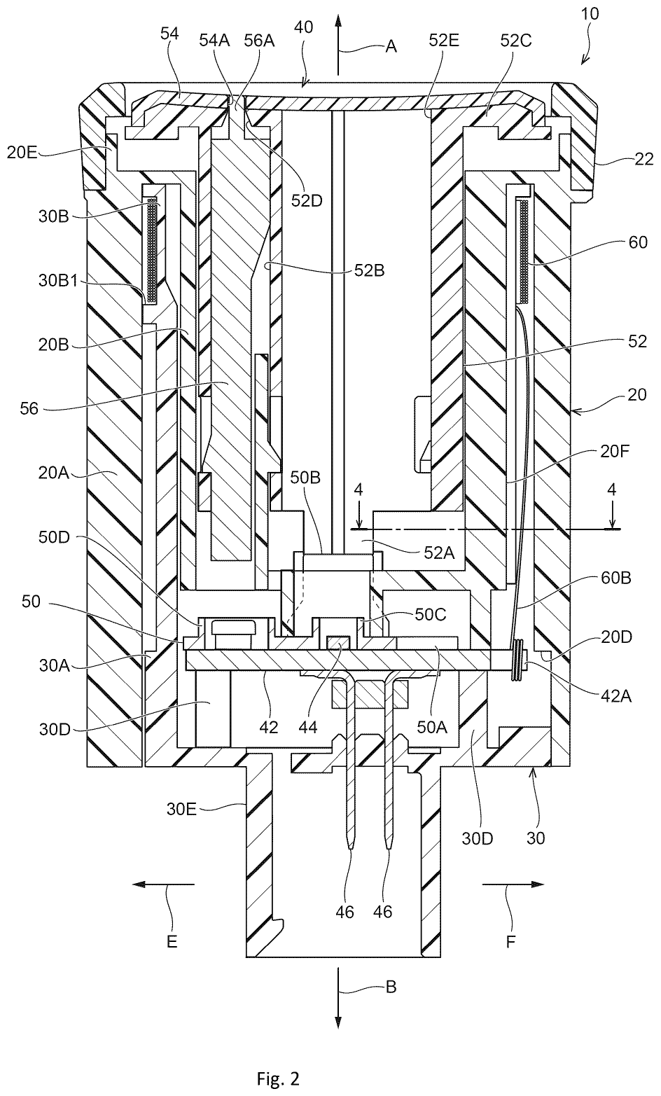

As illustrated in FIG. 2 to FIG. 7, the body 30 is formed in a substantially bottomed cylindrical shape with the front-back direction as the axial direction and open to the front side. The body 30 is inserted into the case 20 from the rear side, and is assembled to the case 20 by means of the claw fit to prevent the relative movement. When the body 30 is assembled to the case 20, the inner cylinder 20B is positioned inside the body 30. In other words, the front portion of the body 30 is disposed between the outer cylinder 20A and the inner cylinder 20B, and the body 30 is covered from radially outward by the outer cylinder 20A. A rear surface of the body 30 is positioned so that it is flush with a rear end surface of the outer cylinder 20A. The outer circumference of the rear end portion of the body 30 has a step portion 30A that rises one step radially outward, and the step portion 30A is fitted into the fitting recess 20D of the case 20.

The front-end portion of the body 30 is configured as a bobbin portion 30B. The bobbin portion 30B is open to radially outward of the body 30 and is formed in a concave shape extending in circumferential direction of the bobbin portion 30B. The inside of the bobbin portion 30B is an antenna wire housing portion 30B1, and the antenna wire 60 described further below is wound around the bobbin portion 30B in the antenna wire housing portion 30B1. When the body 30 is assembled into the case 20, the rear end portion of the bobbin portion 30B is in contact with an inner circumference surface of the outer cylinder 20A, and the body 30 is disposed radially outward of the inner cylinder 20B with a predetermined gap. In other words, the outer cylinder 20A and inner cylinder 20B limit movement of the body 30 in the radial direction.

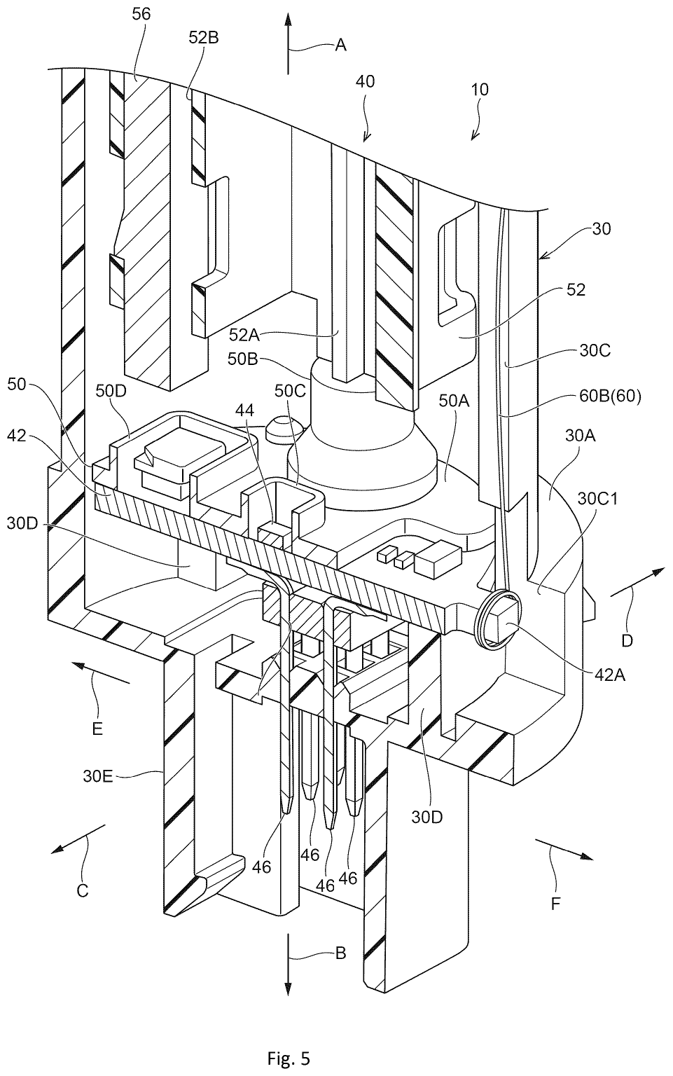

An opening portion 30C is formed in a side wall of the body 30 at other end portion in the second direction. The opening portion 30C is formed in a groove shape with the front-back direction as longitudinal direction and penetrating in the radial direction (second direction), and the front-end portion of the opening portion 30C is open to the front side (see FIG. 5 to FIG. 7). In other words, the portion of the bobbin portion 30B is notched by the opening portion 30C, and the inside of the opening portion 30C and the antenna wire housing portion 30B1 are made to be communicate. The opening portion 30C is formed across the bobbin portion 30B to the step portion 30A, and the rear end portion of the opening portion 30C is configured as an opening-exposed portion 30C1 for disposing and exposing an antenna connection portion 42A of a substrate 42 to be described further below. A width dimension of the opening-exposed portion 30C1 is set to be larger than the width dimension of the opening portion 30C.

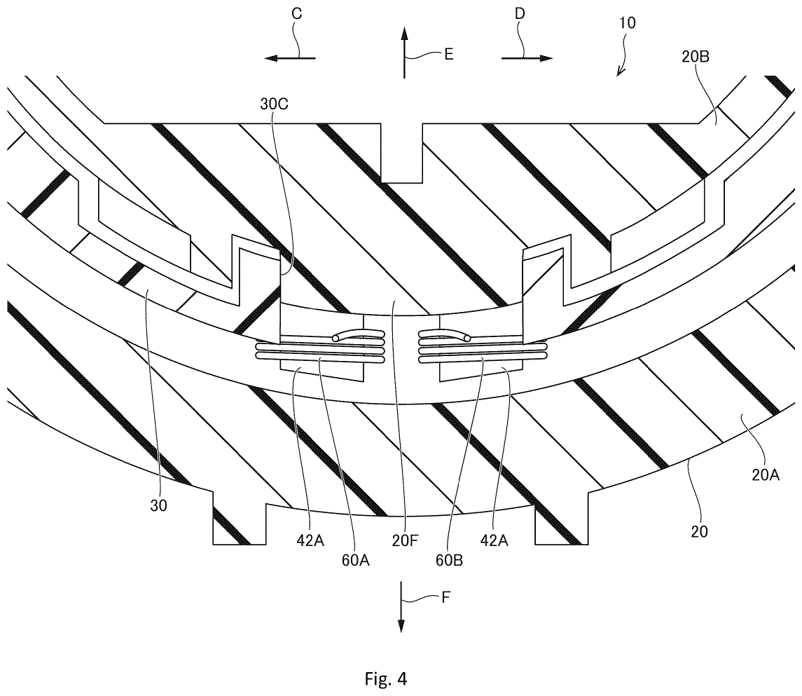

In the outer circumference of the inner cylinder 20B of the case 20 described above, a regulator 20F (see FIG. 2 and FIG. 4) is formed at the other end portion in the second direction (at a position corresponding to the opening portion 30C). The regulator 20F is formed in a column shape extending in the front-back direction and is formed across the front-end portion to the rear end portion of the inner cylinder 20B. The width dimension of the regulator 20F is set slightly smaller than the width dimension of the opening portion 30C, and the regulator 20F is fitted into the opening portion 30C and engaged with the body 30 in the circumferential direction of the body 30.

The rear wall of the body 30 is provided with a plurality of installation ribs 30D for installing the substrate 42 described further below, the installation ribs 30D protruding forward from the rear wall and positioned behind the inner cylinder 20B. The installation rib 30D, at one location is formed in a substantially rectangular plate shape with the second direction as thickness direction, and is disposed close to said one side in the second direction of the opening exposure portion 30C1 so as to cover a rear portion of the opening exposure portion 30C1 from said one side in the second direction (see FIG. 2 and FIG. 5). A connector portion 30E is provided in a substantially central portion of the rear wall of the body 30. The connector portion 30E is formed in a substantially rectangular cylindrical shape with the front-back direction as the axial direction, and protrudes rearward from the rear wall of the body 30.

### Switch Mechanism 40

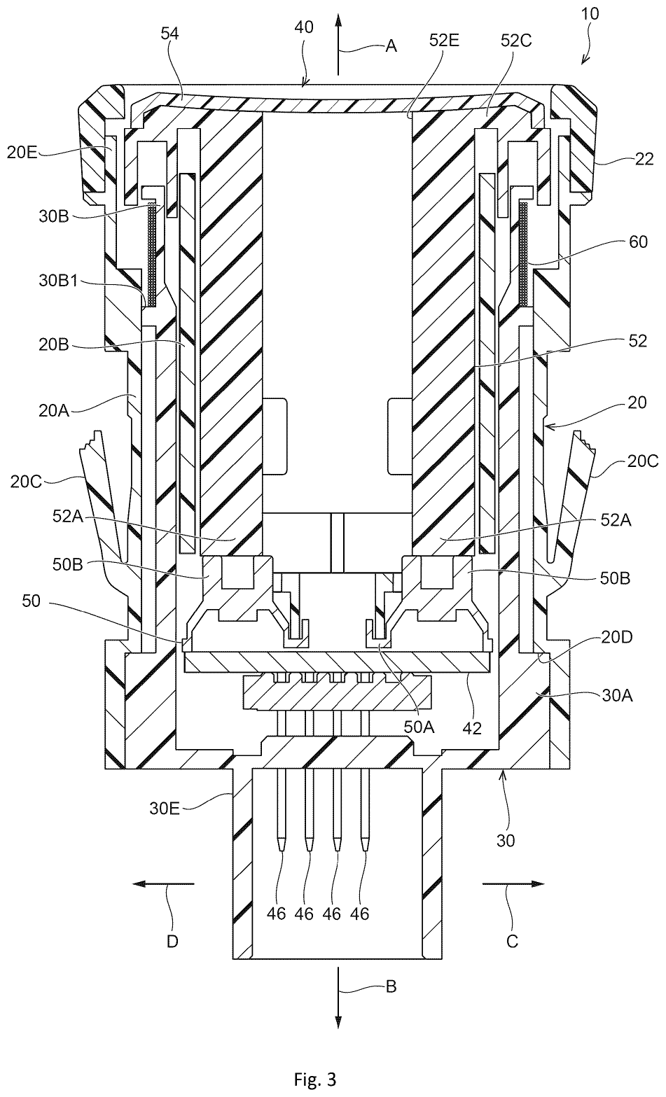

As illustrated in FIG. 2, FIG. 3, and FIG. 5, the switch mechanism 40 is housed inside the body 30. The switch mechanism 40 includes the substrate 42, a rubber contact 50, a slider 52, and the lens 56.

### Substrate 42

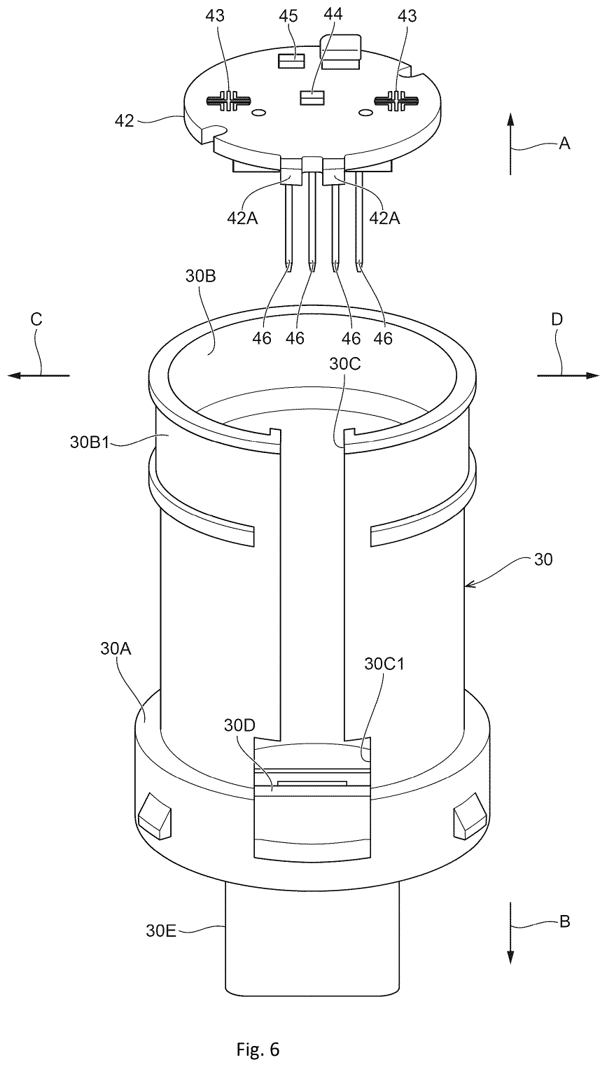

As also illustrated in FIG. 6, the substrate 42 is formed in a substantially disc shape with the front-back direction as the thickness direction. The substrate 42 is housed within the rear end portion of the body 30 and is fixed to the case 20 and body 30 being captured in the front-back direction by the installation ribs 30D of the body 30 and the rear wall of the inner cylinder 20B of the case 20.

Fixed contacts 43 are provided at both end portions of a front surface of the substrate 42 in the first direction. A lighting LED 44 is provided in the substantially central portion of the front surface of the substrate 42, and an indicator LED 45 is provided at one side end portion in the second direction on the front surface of the substrate 42. The lighting LED 44 and the indicator LED 45 are configured to emit light to the front side.

On the rear surface of the substrate 42, a plurality of connector terminals 46 (in the present embodiment, eight connector terminals) are provided, extending in the front-back direction. Four connector terminals 46 are arranged side by side in the first direction, with one set of connector terminals 46 aligned in the first direction and two sets of the connector terminals 46 are arranged side by side in the second direction. The front-end portion of the connector terminal 46 is bent outward in the second direction and connected to the rear surface of the substrate 42. The rear end portion of the connector terminal 46 protrudes rearward from the rear wall of the body 30 and is disposed within the connector portion 30E. The rear wall of the body 30 has an insertion hole formed penetrating which the connector terminal 46 is inserted. An external connector inserted into the connector portion 30E is connected to the connector terminal 46, and the substrate 42 is electrically connected to a controller of the vehicle.

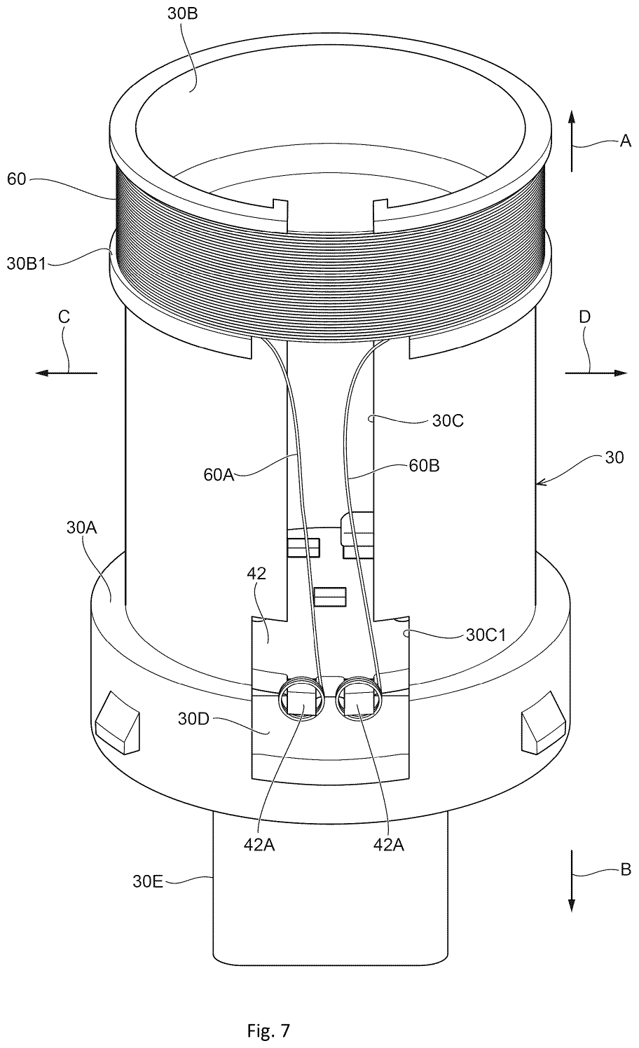

A pair of antenna connection portions 42A are integrally provided at the other end portion in the second direction of the substrate 42. The pair of antenna connection portions 42A are rectangular in radial cross section, protrude radially outward (the other side in the second direction) from the outer circumference of the substrate 42, and are aligned in the first direction. The pair of antenna connection portions 42A are disposed within the substantially central portion of the opening-exposed portion 30C1 of the body 30, and the antenna connection portions 42A are exposed radially outward by the opening-exposed portion 30C1 before the case 20 is assembled to the body 30 (see FIG. 5 and FIG. 7). On the other hand, after assembly of the case 20 to the body 30, the antenna connection portion 42A is covered from radially outward by the outer cylinder 20A of the case 20 (see FIG. 2). When viewed from the front side, the width dimensions of the antenna connection portion 42A and the opening portion 30C are set so that the pair of antenna connection portions 42A are disposed within the opening portion 30C (see FIG. 4). Specifically, distance between a side surface of said one side in the first direction on the antenna connection portion 42A of said one side in the first direction and the side surface of the other side in the first direction on the antenna connection portion 42A of the other side in the first direction is set to be slightly shorter than the width dimension of the opening portion 30C. The surface of the antenna connection portion 42A is plated, and the antenna connection portion 42A and the connector terminal 46 are connected by a pattern formed on the substrate 42. In other words, the antenna connection portion 42A and the connector terminal 46 are conducting. By plating the surface of the antenna connection portion 42A which is shaped radial section rectangular, the corners of radial section rectangle of the antenna connection portion 42A are removed and a shape becomes smoother, which reduces the load on the antenna wire 60 when the antenna wire 60 is wrapped around the antenna connection portion 42A.

### Rubber Contact 50

As illustrated in FIG. 2, FIG. 3, and FIG. 5, the rubber contact 50 has a base portion 50A. The base portion 50A is formed in a plate shape with the front-back direction as the thickness direction and is disposed adjacent to the front side of the substrate 42. The base 50A has a pair of switching portions 50B at positions corresponding to the fixed contacts 43 on the substrate 42. The switching portion 50B is formed in a substantially dome shape rising from the rubber contact 50 toward the front side, and a movable contact (not illustrated) is provided inside the switching portion 50B. The switching portion 50B is configured to be activated when the switching portion 50B is pressed toward the rear side (toward the fixed contact 43). Specifically, the switching portion 50B is configured to turn ON when the movable contact contacts the fixed contact 43.

The base portion 50A has a lighting cylinder portion 50C at a position corresponding to the lighting LED 44. The lighting cylinder portion 50C is formed in the substantially rectangular cylindrical shape and protrudes forward from the rubber contact 50, and the inside of the lighting cylinder portion 50C penetrates in the front-back direction. An indicator cylinder portion 50D is formed in the base portion 50A at the position corresponding to the indicator LED 45. The indicator cylinder portion 50D is formed in the substantially rectangular cylindrical shape and protrudes forward from the rubber contact 50.

### Slider 52

The slider 52 is formed in the substantially rectangular cylindrical shape with the front-back direction as the axial direction. The slider 52 is inserted into the inner cylinder 20B of the case 20 and is coupled with the inner cylinder 20B slidable in the front-back direction. In other words, the slider 52 is housed in the body 30 slidably in the front-back direction. When the slider 52 is housed in the body 30, the front-end portion of the slider 52 protrudes forward from the body 30 and the case 20.

A switch pressure portion 52A is formed on the side wall of the slider 52 at the position corresponding to the switching portion 50B of the rubber contact 50. The switch pressure portion 52A is formed in a substantially cross-shaped column extending in the front-back direction and is disposed adjacent to the front side of the switching portion 50B. A lens housing portion 52B is formed on said one side in the second direction of the slider 52 to house a lens 56 to be described further below. The lens housing portion 52B is formed in the substantially rectangular cylindrical shape with the front-back direction as the axial direction, and is positioned overlapping the indicator LED 45 in a front view.

A knob portion 52C is integrally provided at the front-end portion of the slider 52. The knob portion 52C is formed in the substantially disc shape with the front-back direction as the thickness direction, and extends from the outer circumference of the slider 52 so as to cover the body 30 and the inner cylinder 20B from the front side. A lens hole 52D in a substantially rectangular shape is formed penetrating one side portion in the second direction of the knob portion 52C. A lighting hole 52E is formed penetrating the substantially central portion of the knob portion 52C. The lighting hole 52E is formed in the substantially rectangular shape and is positioned overlapping the lighting LED 44 in the front view.

A design panel 54 is provided on the front side of the knob portion 52C. The design panel 54 is configured with a resin material that can transmit the light. The design panel 54 is formed in a circular shape corresponding to the knob portion 52C in the front view and is concave open to the rear side. The design panel 54 is integrally fixed to the knob portion 52C by two-color molding. The design panel 54 is disposed radially inward of the bezel 22 and is exposed operable to the cabin side of the vehicle. Thereby, the slider 52 slides rearward when an operator operates by pressing the design panel 54 rearward, the switching portion 50B of the switch mechanism 40 is configured to be activated.

An indicator hole 54A is formed penetrating the design panel 54 at the position corresponding to the lens hole 52D of the knob portion 52C. The design panel 54 also has an indicator mark 54B composed of letters, symbols, and so on. The indicator mark 54B is positioned in front of the lighting hole 52E of the knob portion 52C. The indication mark 54B is formed, for example, by painting the front surface of the design panel 54 black and removing the symbol corresponding to the indication mark 54B by laser processing and so on. Thus, the light emitted by the lighting LED 44 passes through the slider 52 and the lighting hole 52E and the display mark 54B is configured to be lighted.

### Lens 56

The lens 56 is configured with a transparent resin material that can transmit the light. The lens 56 is formed in a substantially long plate shape with the second direction as the thickness direction and the front-back direction as the longitudinal direction. The lens 56 is inserted from the rear side into the lens housing portion 52B of the slider 52 and assembled to the slider 52 by means of the claw fit. An indicator portion 56A is provided at the front-end portion of the lens 56. The indicator portion 56A is inserted from the rear side into the lens hole 52D of the knob portion 52C and the indicator hole 54A of the design panel 54, and is exposed from the design panel 54 to the front side. The lens 56 is positioned on the front side of the indicator LED 45, and the light emitted by the indicator LED 45 is guided to the front side by the lens 56 to light the indicator portion 56A.

### Antenna Wire 60

As illustrated in FIG. 2 to FIG. 5 and FIG. 7, the antenna wire 60 is wound around the bobbin portion 30B of the body 30 along the circumferential direction and is disposed in the antenna wire housing portion 30B1. In other words, the antenna wire 60 is wound around the bobbin portion 30B between the outer cylinder 20A and the inner cylinder 20B of the case 20. One end portion 60A and the other end portion 60B as end portions of the antenna wire 60 are extended rearward from the antenna wire housing portion 30B1 and are wired in the opening portion 30C of the body 30. Said one end portion 60A of the antenna wire 60 is wound around and soldered to one of the antenna connection portions 42A on the substrate 42, and the other end portion 60B of the antenna wire 60 is wound around and soldered to the other side of the antenna connection portion 42A on the substrate 42. In other words, said one end portion 60A and the other end portion 60B of the antenna wire 60 are directly connected to the substrate 42, electrically connecting the antenna wire 60 to the connector terminal 46.

### Effects

Next, actions and effects of the switching device 10 of the present embodiment will be described.

In a non-operating state of the switching device 10 configured as described above, the slider 52 is positioned in an initial position (the position illustrated in FIG. 2 and FIG. 3). When the design panel 54 of the slider 52 is operated by pressing, the slider 52 slides to the rear side. This causes the switch pressing portion 52A of the slider 52 to press the pair of switching portions 50B of the rubber contacts 50. Thus, the movable contacts of the pair of switching portions 50B contact the fixed contacts 43 of the substrate 42, the pair of switching portions 50B are turned ON and an ON signal is output to the controller of the vehicle. On the other hand, when an operation to the slider 52 is released, the slider 52 slides forward by restoring force of the switching portion 50B of the rubber contact 50. This causes the knob portion 52C to return to the initial position.

The controller of the vehicle is connected by communications to a portable device owned by the operator, and an engine (power unit) of the vehicle is started or stopped when the switching device 10 is operated with an authentication with the portable device completed. The switching device 10 has the antenna wire 60. Therefore, when a battery of the portable device owned by the operator is drained and the communications with the portable device become impossible, transponder communications can be used to communicate with the portable device. In detail, when the portable device is held over the design panel 54 of the switching device 10, the portable device receives a startup radio wave transmitted from the antenna wire 60 in a coiled shape of the switching device 10. Electromotive force is generated by the coil portion in a transponder of the portable device. Electric power generated allows the portable device to transmit ID signals to an authentication device of the vehicle, thus the authentication device of the vehicle and the portable device can communicate.

Here, the switching device 10 has a cylindrical body 30. The bobbin portion 30B is provided at the front-end portion of the body 30, and the antenna wire 60 is wound around the bobbin portion 30B. The substrate 42 is disposed inside the body 30, and the connector terminal 46 is provided on the rear surface of the substrate 42. Further, the substrate 42 has the antenna connection portion 42A that is conducted to the connector terminal 46, and said one end portion 60A and the other end portion 60B of the antenna wire 60 are soldered to the antenna connection portion 42A. This allows the antenna wire 60 to be connected to the connector terminal 46 while manufacturing the body 30 at a lower cost, compared with a body in which the connector terminal is insert molded as in conventional technology. In other words, by directly connecting the antenna wire 60 to the substrate 42 on which the connector terminal 46 is provided, the body 30 can be manufactured at a lower cost. Thus, the manufacturing costs of the switching device 10 can be reduced.

The side wall of the body 30 has the opening portion 30C penetrating in the radial direction, and the opening portion 30C exposes the antenna connection portion 42A to radially outward of the body 30. This allows said one end portion 60A and the other end portion 60B of the antenna wire 60 wound around the bobbin portion 30B to be connected to the antenna connection portion 42A which is exposed through the opening portion 30C. This can improve workability during assembly of the switching device 10. Thus, the manufacturing costs of the switching device 10 can be further reduced.

The bobbin portion 30B is formed in the concave shape open to radially outward of the body 30, and the inside of the bobbin portion 30B is used as the antenna wire housing portion 30B1. The antenna wire housing portion 30B1 is made to communicate to the opening portion 30C. As a result, said one end portion 60A and the other end 60B of the antenna wire 60 wound around the bobbin portion 30B can be drawn from the antenna wire housing portion 30B1 to the rear side and wired in the opening portion 30C to connect to the antenna connection portion 42A exposed through the opening portion 30C (opening-exposed portion 30C1). In addition, draw-out points from the antenna wire 60 wound around the bobbin portion 30B at said one end portion 60A and the other end portion 60B can be clearly identified by the opening portion 30C. This further improves workability during assembly of the switching device 10. Thus, the manufacturing costs of the switching device 10 can be further reduced.

The antenna connection portion 42A protrudes from the outer circumference of the substrate 42 to the radially outward of the body 30 and is disposed within the opening-exposed portion 30C1 of the opening portion 30C. This allows said one end portion 60A and the other end portion 60B of the antenna wire 60 to be soldered to the antenna connection portion 42A with the antenna connection portion 42A disposed radially outward from the inner circumference of the body 30. Therefore, the workability of soldering the antenna wire 60 to the antenna connection portion 42A can be further improved.

Furthermore, in the body 30, the width dimension of the opening-exposed portion 30C1 is wider than the width dimension of the opening portion 30C, and the antenna connection portion 42A is disposed in the opening-exposed portion 30C1. This allows rigidity of the body 30 to be secured, while at the same time to provide a working area when soldering the antenna wire 60 to the antenna connection portion 42A.

The opening portion 30C is formed in the groove shape extending in the front-back direction, and the front-end portion of the opening portion 30C is open to the front side at the front-end portion of the body 30. As a procedure for assembling the substrate 42 and antenna wire 60 into the body 30, first, the substrate 42 can be disposed on the front side of the body 30 (see FIG. 6), and from this state, the substrate 42 can be housed in the body 30 while the antenna connection portion 42A is inserted into the opening portion 30C from the front side. In other words, the substrate 42 can be housed in the body 30 while the interference of the antenna connection portion 42A with the body 30 is reduced by the opening portion 30C. After housing the substrate 42 in the body 30, the antenna wire 60 can be wound around the bobbin portion 30B, and then said one end portion 60A and the other end portion 60B of the antenna wire 60 can be connected to the antenna connection portion 42A disposed within the opening-exposed portion 30C1 by soldering (see FIG. 7). This effectively improves workability during assembly of the switching device 10. Thus, the manufacturing costs of the switching device 10 can be effectively reduced.

As described above, the antenna connection portion 42A protrudes radially outward from the outer circumference of the substrate 42, and said one end portion 60A and the other end portion 60B of the antenna wire 60 are soldered to the antenna connection portion 42A. In other words, the antenna connection portion 42A constitutes the portion of the substrate 42, and the surface of the antenna connection portion 42A is plated to electrically connect the antenna connection portion 42A to the connector terminal 46 by the pattern. This allows the substrate 42 to be manufactured at a lower cost than, for example, a configuration in which a connecting terminal is provided separately on the substrate 42 to connect the antenna wire 60 to the substrate 42.

The body 30 is fixed to the case 20. The case 20 includes the outer cylinder 20A covering the body 30 from radially outward and the inner cylinder 20B disposed inside the body 30, and the slider 52 is slidably coupled with the inner cylinder 20B in the front-back direction. This eliminates need to provide a structure in the body 30 to slidably couple with the slider 52. Therefore, the body 30 with the bobbin portion 30B can be made into a simple structure. In other words, the shape of the body 30 can be reduced in complexity. This can further contribute to cost reduction of the body 30.

The bobbin portion 30B is disposed between the outer cylinder 20A and the inner cylinder 20B of the case 20. In other words, the antenna wire 60 is disposed between the outer cylinder 20A and the inner cylinder 20B, and is covered from radially outward by the outer cylinder 20A. This improves, for example, waterproofness and dust proofness for the antenna wire 60. Thus, reliability can be improved in the switching device 10.

After the body 30 is assembled into the case 20, the antenna connection portion 42A is covered from radially outward by the outer cylinder 20A of the case 20. This allows the case 20 to ensure the waterproofness and the dust proofness for the antenna connection portion 42A even though the antenna connection portion 42A is configured to be exposed from the body 30 by the opening portion 30C.

In an assembled state of the body 30 to the case 20, the rear end portion of the bobbin portion 30B is in contact with the inner circumference surface of the outer cylinder 20A, and the body 30 is disposed radially outward of the inner cylinder 20B with the predetermined gap, and the movement of the body 30 in the radial direction is limited by the outer cylinder 20A and inner cylinder 20B. Thereby, even if the portion of the side wall of the body 30 is notched by the opening portion 30C, the radial deformation of the side wall can be reduced by the case 20.

The outer circumference of the inner cylinder 20B of the case 20 has the regulator 20F at the other end portion in the second direction, and the regulator 20F is fitted into the opening portion 30C and engaged with the body 30 in the circumferential direction of the body 30. Thereby, even if the portion of the side wall of the body 30 is notched by the opening portion 30C, the deformation of the side wall in the circumferential direction can be reduced by the regulator 20F. In addition, by forming the regulator 20F on the outer circumference of the inner cylinder 20B, the regulator 20F can be fitted into the opening portion 30C while reducing interference between the antenna wire 60 wound around the bobbin portion 30B and the regulator 20F.

The antenna connection portion 42A is formed integrally with the substrate 42, protruding radially outward from the outer circumference of the substrate 42. This eliminates the need for a separate material such as a terminal, for example, as the antenna connection portion 42A, further reducing manufacturing costs.

In the present embodiment, “soldering” is adapted as a means of fixing said one end portion 60A and the other end portion 60B of the antenna wire 60 to the antenna connection portion 42A, but a method of fixing the antenna wire 60 and the antenna connection portion 42A is not limited to this. For example, “welding” or other methods may be used to fix the antenna wire 60 and the antenna connection portion 42A.

In the present embodiment, said one end portion 60A and the other end portion 60B of the antenna wire 60 are fixed by soldering after being wound around the antenna connection portion 42A, but the method of connecting the antenna wire 60 to the antenna connection portion 42A is not limited to this. For example, a through hole may be formed in the antenna connection portion 42A, and said one end portion 60A or the other end portion 60B of the antenna wire 60 may be inserted into the through hole and then fixed by soldering.

In the present embodiment, the antenna wire 60 is electrically connected to the connector terminal 46 by providing the antenna connection portion 42A on the outer circumference of the substrate 42 and soldering said one end portion 60A and the other end portion 60B of the antenna wire 60 to the antenna connection portion 42A, but the method of connecting the antenna wire 60 to the connector terminal 46 is not limited to this. For example, although the figure is omitted, the connecting terminal that is conductive to the connector terminal 46 may be provided on the substrate 42, said one end portion of the connecting terminal may be exposed through the opening portion 30C, and said one end portion 60A and the other end 60B of the antenna wire 60 may be soldered to said one end portion of the connecting terminal. In this case, the connecting terminal corresponds to the antenna connection portion of the present application.

### EXPLANATION OF THE REFERENCE NUMERALS

10: Switching device
20: Case
20A: Outer cylinder
20B: Inner cylinder
20F: Regulator
30: Body
30B: Bobbin portion
30C: Opening portion
42A: Antenna connection portion
46: Connector terminal
50B: Switching portion
52: Slider
60: Antenna wire
60A: One end portion (end portion)
60B: Other end portion (end portion)

1. A switching device comprising:
a body formed in a cylindrical shape and having a bobbin portion at one side end portion in axial direction;
an antenna wire wound around the bobbin portion;
a slider configured to be slidable in the axial direction within the body;
a switching portion pressed by the slider when sliding to other side in the axial direction of the slider; and
a substrate that is disposed inside the body and has a connector terminal, with an antenna connection portion that is conductive to the connector terminal and connected to an end portion of the antenna wire.

2. The switching device according to claim 1 wherein an opening portion radially penetrated is formed in a side wall of the body, and the antenna connection portion is exposed radially outward of the body by the opening portion.

3. The switching device according to claim 2,
wherein the bobbin portion is formed in a concave shape which is opened radially outward of the body; and
wherein inside of the opening portion communicates with the inside of the bobbin portion.

4. The switching device according to claim 3 wherein the antenna connection portion protrudes radially outward from an outer circumference of the substrate and is disposed within the opening portion.

5. The switching device according to claim 4 wherein the opening portion is formed in a groove extending in the axial direction of the body, and one end portion of the opening portion is opened to one side in the axial direction at said one end portion of the body.

6. The switching device according to claim 2,
wherein a case is fixed to the body; and
wherein the case includes an outer cylinder covering the body from radially outward and an inner cylinder disposed radially inward of the body, and wherein the slider is slidably coupled with the inner cylinder.

7. The switching device according to claim 6 wherein the bobbin portion is disposed between the outer cylinder and the inner cylinder.

8. The switching device according to claim 7 wherein the bobbin portion contacts the outer cylinder from radially inward, and the outer cylinder and the inner cylinder restrict movement of the side wall of the body in the radial direction.

9. The switching device according to claim 6,
wherein a regulator is provided on an outer circumference of the inner cylinder; and
wherein the regulator is fitted into the opening portion and engaged with the body in circumferential direction of the body.

10. The switching device according to claim 1 wherein the antenna connection portion is formed integrally on the substrate, protruding radially outward from an outer circumference of the substrate.
